(19) United States
(12) Patent Application Publication
(10) Pub. No.: US 2008/0091447 A1
(43) Pub. Date: Apr. 17, 2008

(54) Discrete pest management for public accommodations

(76) Inventor: Eileen T. Gilmore, Boise, ID (US)

Correspondence Address: PEDERSEN & COMPANY, PLLC, P.O. BOX 2666, BOISE, ID, 83701, US

(21) Appl. No.: 11/582,012

(22) Filed: Oct. 16, 2006

(51) Int. Cl. G06Q 10/00; G06Q 30/00; H04L 9/00; H04K 1/00

(52) U.S. Cl. 705/1; 705/80

(57) ABSTRACT

A method for discrete pest management, preferably for public accommodations. The service provider dresses and behaves as a usual repairperson for the establishment. The attire of the service provider does not bear any logos or emblems that would indicate a need to patrons for pest management. Inspections are conducted, and a quality assurance seal is provided if no infestation is detected. If an infestation is detected, an extermination provider is arranged to apply curative treatment. The extermination provider is trained in the discretionary tactics of the service provider, and conducts itself on the customer's property the same as the service provider. Once the infestation is eradicated, a quality assurance seal is provided. The service provider may offer a comprehensive pest package, or may only offer service for a particular pest. Periodic inspections are conducted by the service provider for uninterrupted quality assurance during the term of the contract.

### BACKGROUND OF THE INVENTION

1. Field of the Invention

The present invention is related to pest control services, and more particularly to services that feature discretion and imperceptibility during inspection and treatment, as well as continued quality assurance for the customer.

2. Background of the Invention

Current strategies for pest control services typically begin with the application of measures to control pests only after infestation has occurred, and can include further inspections and services to maintain elimination of the pests. In this strategy, a customer first contacts a pest control service provider, often after an infestation has been detected. The pest control service provider typically arranges a one-time service agreement, which includes inspection and treatment, if necessary, of the problem. The service may involve multiple visits by the provider, but the terms of the agreement are usually for a determined course of treatment, either as a fixed number of visits or length of time, and the treatment may be specified for a particular pest. The customer is then charged for the services provided under the agreement, either before or after the services are rendered. Many strategies also include a warranty plan upon payment of the service fees by the customer, so that further inspection and treatment may be applied if re-infestation is detected within the warranty period.

One strategy, Springer, U.S. Published Application No. 2004/0068414, recognizes the value of preventative measures for pest control, rather than merely curative measures. Preventing an infestation before it occurs will spare the customer costs, effort, and intrusiveness over time, in addition to being more likely to succeed. Springer, therefore, arranges for the customer to be automatically debited for the regular maintenance fees and services associated with pest prevention and control.

A primary objective of the present invention is to provide a method for the inspection of pests, specifically bedbugs.

Another objective of the present invention is to provide discrete and imperceptible pest control services to public establishments, especially those with sleeping quarters.

Another objective of the present invention is to provide continuous, uninterrupted quality assurance to establishments where inspection confirms there are no pests.

### SUMMARY OF THE INVENTION

An embodiment of the present invention addresses the issue of patron perception of a pest problem. Pests are typically understood to suggest the presence of filth and disease. Consequently, public establishments, especially those in the hospitality industry, are negatively affected any time their patrons perceive a problem with pests; consumers do not want to eat or sleep in a place with infestation. In the present invention, public establishments are protected from the perception of a pest problem, because employees of the pest control service provider conduct themselves with the utmost discretion and imperceptibility. When a contract is arranged between the customer and the service provider, pest inspectors come to the location of business dressed as typical service or repair people for the establishment, and carrying any pest control equipment or tools in luggage or toolboxes. There are no logos or emblems of any kind that would indicate a pest control operator on the inspector's attire, since these might indicate to patrons there is a need for pest control or extermination. Additionally, the inspector's vehicle should be similar to that of a service or repair person, and should also not bear any logos or emblems indicating pest control. All employees of the service provider will be required to sign a secrecy agreement related to the business of the service provider and its employees, as well as undergo a background check for security.

If no infestation is discovered during the inspection, a quality assurance seal is placed in a visible location on the premises. The quality assurance seal will have the effect of guaranteeing the premises are monitored and treated to prevent pest infestation. If an infestation is discovered during the inspection, the service provider notifies the customer immediately, and arranges for extermination treatment. Inspection and curative treatment of an infestation may be outsourced to an established extermination provider, in which employees of the extermination provider will be trained in the discretionary tactics of the service provider, and will conduct themselves the same as employees of the service provider. Once the infestation has been eradicated, and the inspectors are satisfied there is no further infestation of the property, a quality assurance seal is placed in a visible location on the premises.

The service provider will offer either a comprehensive pest package to treat for a complete range of pests, or the service provider may opt to specialize in the monitoring and treatment of a particular pest. The service provider will guarantee continuous, uninterrupted quality assurance to the customer for the term of the contract, by providing regular follow-up inspections of the property. The frequency of follow-up inspections will be determined by the service provider, and may vary depending upon the region in which the property is located, and the type of pests for which the inspectors search. Should the customer detect a problem in between inspections, the customer may contact the service provider, who will immediately re-inspect the property without waiting for the next regularly scheduled inspection.

### BRIEF DESCRIPTION OF THE DRAWINGS

FIG. 1 is a flowchart showing the method in accordance with an embodiment of the present invention.

### DETAILED DESCRIPTION OF THE INVENTION

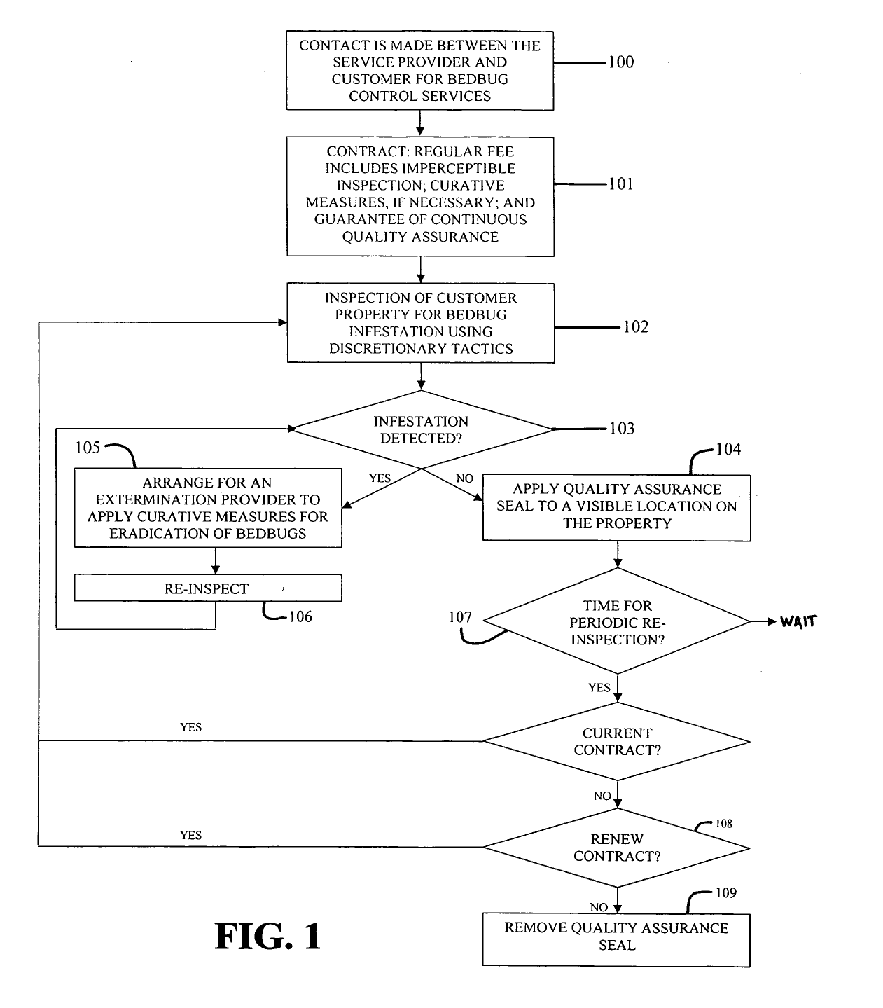

FIG. 1 is a flowchart that illustrates one embodiment for the method of the present invention. In the preferred embodiment, the customer is a public establishment, especially with sleeping quarters, such as a hotel. The pest control service provider initiates contact (100) with the customer by means of a personal visit to the customer's location of business. Alternatively, the service provider could contact (100) the customer via mail or a telephone call, or the customer could initiate contact (100) with the service provider. A contract (101) is arranged between the customer and service provider for an initial inspection of the premises, and any follow-up inspections of the premises, in exchange for payment from the customer to the service provider.

The service provider inspects (102) the property using the most current and effective techniques available, which may vary depending upon the region in which the property is located and the type of pests for which the inspectors search. In the preferred embodiment, the pest is Cimex lectularius, or the “bedbug.” The inspection (102) is performed with the utmost discretion and imperceptibility, so as not to alert patrons of the establishment to any possibility, real or imagined, of a pest problem. Because pests are typically understood to indicate the presence of filth and disease, imperceptibility is very advantageous to any public establishment, especially those in the hospitality industry, where patrons are likely not to return to the establishment if they believe there to be a problem with pests. To assure that discretion is maintained, secrecy agreements with regards to the business of the pest control service provider and its employees will be signed by all service provider employees. Such secrecy agreements may also be required by all or some of the establishment employees.

The pest inspectors are to maintain a very clean, well-groomed appearance. Inspectors' attire is to be cleaned and pressed, although there may or may not be an official uniform, due to the model of discretion that is to be presented. In order to achieve discretion and imperceptibility, the preferred embodiment for inspectors' attire is similar to that of the establishment's regular service or repair crews, such as HVAC service, electrical or plumbing maintenance, etc., and does not bear any logo, emblem, or other indication of the pest control service provider. Inspectors are to blend in with the appearance of the establishment's expected service people, thereby becoming “invisible” to patrons, and this may include the use of wheeled luggage or toolboxes for carrying pest control equipment, analytical instrumentation, or other tools. Dressed as a regular maintenance crewperson, the inspectors will be able to be seen entering into multiple different rooms within the same day by the same patron, without the patron perceiving the inspector as “pest control.” Further, inspectors are to maintain quality customer service at all times, which demands courtesy, friendliness, and respect for the customer and its employees, as well as all of the customer's patrons.

The vehicle driven by inspectors is also to be similar to that of the establishment's regular service or repair crews, such as a neutral-colored van, minivan, or sports-utility-vehicle, or any other form of transportation commonly used in connection with utility functions. This vehicle shall also not bear any logo, emblem, or other indication of the pest control service provider. The intention of this camouflage is not to deceive for any unscrupulous purposes, but only to maintain the emotional comfort and confidence of the guests who may observe the service providers at work.

Each employee of the pest control service provider will be required to undergo a background check for security, since the inspectors and other employees may be granted access to many locked, private areas of the establishment. The service provider may provide the establishment with a copy of valid employees' driver's licenses for verification of employee identity upon arrival for service.

Upon initial inspection (102) of the premises, pests are either detected or they are not detected (103), at which time the appropriate protocol is followed by the inspectors. If an infestation is not detected, a quality assurance seal bearing the service provider's company name, and, for example, initials of the inspector, and date of inspection, is placed (104) in a visible location on the premises, such as a front-facing window, or over the front door handle. If an infestation is detected, a quality assurance seal is not provided to the customer at the time of inspection. Instead, the inspector notifies the customer that an infestation has been detected, and then arranges for pest extermination (105).

The pest extermination provider may be a division of the service provider, or may be a separate entity operating under an outsourcing, marketing, or franchise agreement with the service provider. In this capacity, the pest extermination provider will be trained to conduct him or herself the same as an employee of the service provider. When the pest extermination provider is on the customer's premises, he or she will act the same as an inspector of the service provider, wearing the appropriate attire and carrying equipment in the appropriate bags. He or she will also act with courtesy, friendliness, and respect, and will practice discretion and imperceptibility.

Because the property is preferably a public establishment, the part of the property determined to be infested should be decommissioned from public utility until curative treatment is applied and the service provider is satisfied that no further infestation exists. For example, if the property is a hotel in which each guest room has been contracted (101) to be inspected by the service provider, then any guest room where infestation is detected should be immediately removed from the course of regular operation until the appropriate measures (105) for extermination have been taken. Once the service provider has re-inspected (106) the property, and is satisfied it is free from pests, a quality assurance seal bearing the service provider's company name, and, for example, initials of the inspector, and date of the most recent inspection, is placed (104) in a visible location on the property, such as a front-facing window, or over the front door handle.

Because the quality assurance seal will have the effect of guaranteeing to customers and to patrons that the property is being monitored and treated to prevent pest infestation, the service provider will need to provide services for a comprehensive pest package. There may be a menu of pest types within the contract (101) for the customer itself to select from. The package offered by the service provider must be able to guarantee the property is fully monitored. Alternatively, the service provider may specialize in the eradication of a particular type of pest, so that when the quality assurance seal is placed (104) on the property, the service provider's company name represents that the property is fully monitored and treated for that pest. For example, in the embodiment shown in FIG. 1, the service provider has selected to specialize in the monitoring and treatment of bedbugs. Therefore, the quality assurance seal has the effect of guaranteeing to customers and to patrons that the property is being monitored and treated for any infestation of bedbugs, and that, while a 100% guarantee against a single bedbug is impossible, there is no active infestation currently present on the property.

The contract (101) between the customer and the service provider (“the contract”) preferably arranges for periodic inspections (107), and treatments as necessary (“service events”). The service provider inspects (102) the customer's property when the next service event is due, using the same techniques and protocols as with the initial inspection. If no infestation is detected, then the quality assurance seal is again initialed (104) by the inspector, and dated with the most recent date of inspection. If re-infestation is detected, then the property is decommissioned from public utility until the pest extermination provider can apply (105) curative treatment to eradicate the pests. Once the pests have been successfully eradicated (106), the quality assurance seal (104) is initialed by the inspector, and dated with the most recent date of inspection. If the customer detects a problem between scheduled service events, the customer can contact the service provider, who will immediately provide the appropriate service without waiting for the next service event.

The terms of the contract (101) set forth the obligations of the service provider, who will: complete the initial inspection (102) and arrange (105) for any necessary extermination services; provide proof of quality assurance (104) in the form of a clearly visible seal and/or warranty; provide periodic follow-up inspections (107) and pest management services for continued quality assurance; and conduct itself with the utmost discretion and imperceptibility. The service provider will determine the frequency of follow-up visits (107) that is required for continued quality assurance, which may vary depending upon the region in which the property is located and the type of pests for which the inspectors search. For example, bedbug inspections may occur every day, because of the traveling and spreading nature of the bedbug with each guest.

The terms of the contract (101) also include the understanding of the customer. The customer understands the frequency (107) with which service events will occur, the scope of the services (e.g. area and type of pests to be controlled), the method of payment, and the contract term length. The customer will determine the length of time for which it wishes to maintain regular pest management services and quality assurance, for example, a two-year, three-year, or five-year contract. The service provider will then provide regularly scheduled service events (107), plus any additional service events required by the customer, for the length of time chosen by the customer. The dates and times for these service events may be selected at the time of the contract (101) or at another time.

Upon expiration of the term of the contract (101), the customer is no longer covered for pest management services unless it renews (108) its contract with the service provider. If the customer chooses to renew (108) the contract, then service events will continue uninterrupted at the same interval. At this time, the customer may choose to alter the terms of the original contract (101), for example, by selecting coverage for a different area of the property, or by changing the contract term length. If the customer does not wish to renew (108) the contract, then service events will be discontinued, and the quality assurance seal will be removed (109) from the property by the service provider.

Although this invention has been described above with reference to particular means, materials and embodiments, it is to be understood that the invention is not limited to these disclosed particulars, but extends instead to all equivalents within the scope of the following claims.

What is claimed is:

1. A method for providing pest control services to public accommodations, including:
agreeing to provide regular pest inspections and continuous quality assurance to the customer in accordance with a contract;
inspecting the property for pests in a manner that avoids the perception of a pest problem by patrons;
if any pests are detected, arranging for the extermination of them; and,
guaranteeing uninterrupted quality assurance to the customer by providing regularly scheduled inspections in accordance with a contract.

2. The method of claim 1, wherein the contract offers service for a comprehensive pest package.

3. The method of claim 1, wherein the contract offers service for a particular type of pest only.

4. The method of claim 1, wherein regular inspections occur on a daily basis.

5. The method of claim 1, wherein the pest inspectors' attire and equipment bags are suited to a typical patron of the accommodation establishment.

6. The method of claim 1, wherein pest extermination is accomplished by an outside contractor.

7. The method of claim 1, wherein a seal is placed in a visible location on the property, indicating that the property is monitored and treated to be free from pest infestation.
